(19) United States
(12) Patent Application Publication
(10) Pub. No.: US 2007/0179818 A1
(43) Pub. Date: Aug. 2, 2007

(54) Integrated method and system for claim submission, processing, resolution and advance funding

(75) Inventor: Neal Magnus, New York, NY (US)

Correspondence Address: ARENT FOX PLLC, 1050 CONNECTICUT AVENUE, N.W., SUITE 400, WASHINGTON, DC, 20036, US

(73) Assignee: Medtrx Capital, LLC

(21) Appl. No.: 11/700,129

(22) Filed: Jan. 31, 2007

Related U.S. Application Data
(60) Provisional application No. 60/763,354, filed on Jan. 31, 2006.

(51) Int. Cl. G06Q 40/00

(52) U.S. Cl. 705/4

(57) ABSTRACT

A method and system for integrated claim processing is provided that includes features and functions for entering claim-related data in a memory, generating a claim form and storing the claim form in the memory, transmitting the claim form to an insurance carrier, determining whether the claim will be paid by the insurance carrier, providing advance funding to the claimant, and deciding appropriate course of action on the basis of the determination. A method and system for undertaking a legal action that includes preparing a demand letter, transmitting the demand letter to the insurance carrier, generating an attestation of service as proof of transmittal, selecting an attorney from a list of available attorneys, determining venue and cause of action, filing a lawsuit, and maintaining a state diagram indicating the current status of the case.

This application claims priority from U.S. provisional application No. 60/763,354, filed Jan. 31, 2006, which is incorporated herein by reference in its entirety.

### BACKGROUND OF THE INVENTION

1. Field of the Invention

The present invention relates to a method and system for submission, processing and resolution of insurance-related claims. Specifically, the present invention relates to a method and system for the integrated management of the submission, processing, resolution and advance funding of healthcare-related no-fault insurance claims.

2. Background of the Related Art

One problem in the healthcare industry today is that no integrated methods and systems exist for integrated submission, processing, and resolution of insurance claims, such as, for example, no-fault insurance claims. Currently, the entities that typically prepare and process insurance claims in the healthcare industry are physicians and/or healthcare practitioners. Unfortunately, most of the preparation and processing is performed manually, without an adequate system for tracking correspondence with patients, insurance carriers and/or courts or arbitration panels (if subsequent litigation or arbitration is initiated), and any other entities involved in the claim submission, processing, and resolution process. Furthermore, physicians and medical personnel are often not adequately trained to perform any actions related to the submission, processing, and final resolution of insurance claims, and performance of these actions is generally not related to the core functions of medical office staff.

Due to the relatively high complexity of the process, the relatively low level of sophistication of claimants in filing and processing insurance claims, and the lack of an integrated method and system for filing, processing, and resolving such claims, a large proportion of the filed claims are dismissed, abandoned, or otherwise fail to reach final resolution. Furthermore, many claimants reach disadvantageous settlement agreements with insurance carriers to settle their claims, as a result.

There is a need, therefore, for a method and system for the integrated management of the submission, processing, and resolution of healthcare-related insurance claims. There is also a need for such methods and systems to mitigate the effects of the relatively low level of sophistication of claimants in filing and pursuing insurance claims.

### SUMMARY OF THE INVENTION

In light of the above described problems and shortcomings as well as others, various exemplary embodiments according to this invention provide a methods and systems for integration of claim processing that include entering claim-related data in a memory, generating a claim form and storing the claim form in memory, wherein the claim form is automatically generated, transmitting the claim form to an insurance carrier, determining whether the claim will be paid by the insurance carrier, and determining an appropriate course of action on the basis of the claim payment determination.

The present invention provides a method and system for the integrated management of the submission, processing, resolution and advance funding of healthcare-related no-fault insurance claims. Further, the present invention provides a method and system for the integrated management of the submission, as well as processing and resolution of such claims, which complies with the relatively complex statutory requirements for processing and managing the submission and management of these claims, while documenting the process and thereby documenting compliance with these requirements. The present invention also provides a method and system for the integrated management of filing and pursuing no-fault insurance claims, in a manner that mitigates complexity effects for relatively low level of sophistication claimants. Further, the present invention provides a method for advance funding of claims, based on predicted anticipated payments to be received by the claimant, and a predicted likelihood that such payments will be made.

Details of these and other advantages and novel features of the invention will be set forth in part in the description that follows, and in part will become more apparent to those skilled in the art upon examination of the following or upon learning by practice of the invention.

### BRIEF DESCRIPTION OF THE DRAWINGS

Various exemplary embodiments of the systems and methods will be described in detail, with reference to the following figures, wherein:

FIG. 1 illustrates an exemplary open system architecture according to an embodiment of the present invention;

FIGS. 2A-2B illustrate an example flow diagram of functions performed in accordance with an embodiment of the present invention;

FIG. 3 illustrates an exemplary system diagram of various hardware components and other features, in accordance with an embodiment of the present invention;

FIG. 4 illustrates an exemplary system diagram of various hardware components and other features in accordance with an embodiment of the present invention; and

FIGS. 5-9 show various illustrations of claim forms and databases used according to various exemplary embodiments.

### DETAILED DESCRIPTION OF THE INVENTION

These and other features and advantages of this invention are described in, or are apparent from, the following detailed description of various exemplary embodiments of the systems and methods according to this invention.

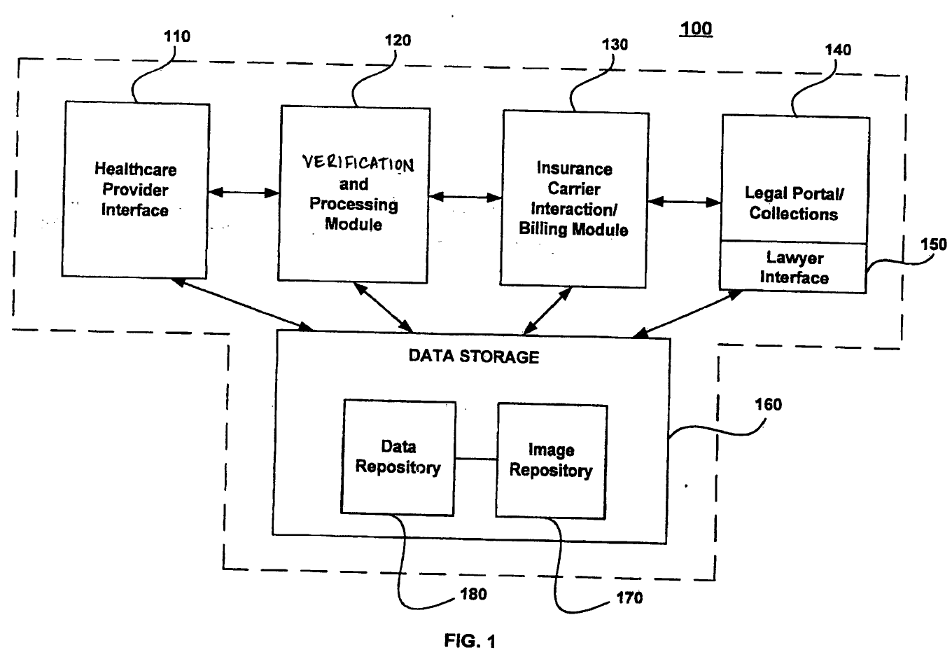

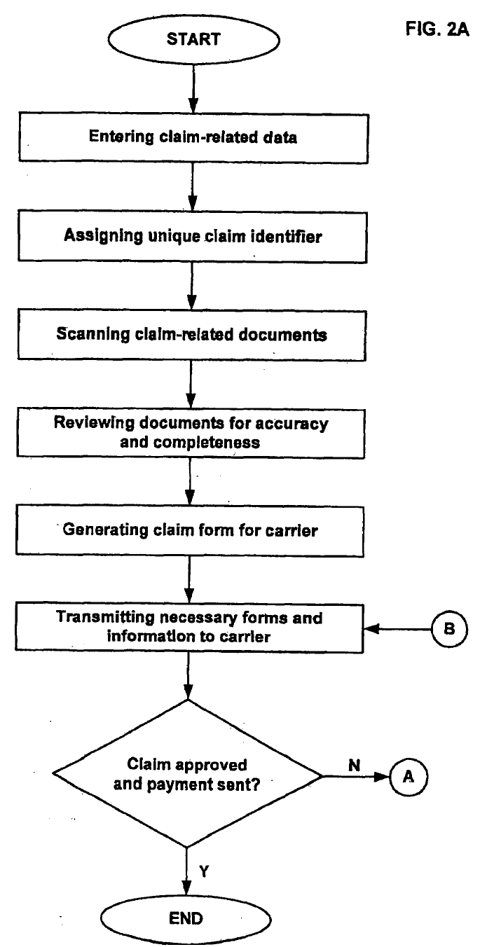

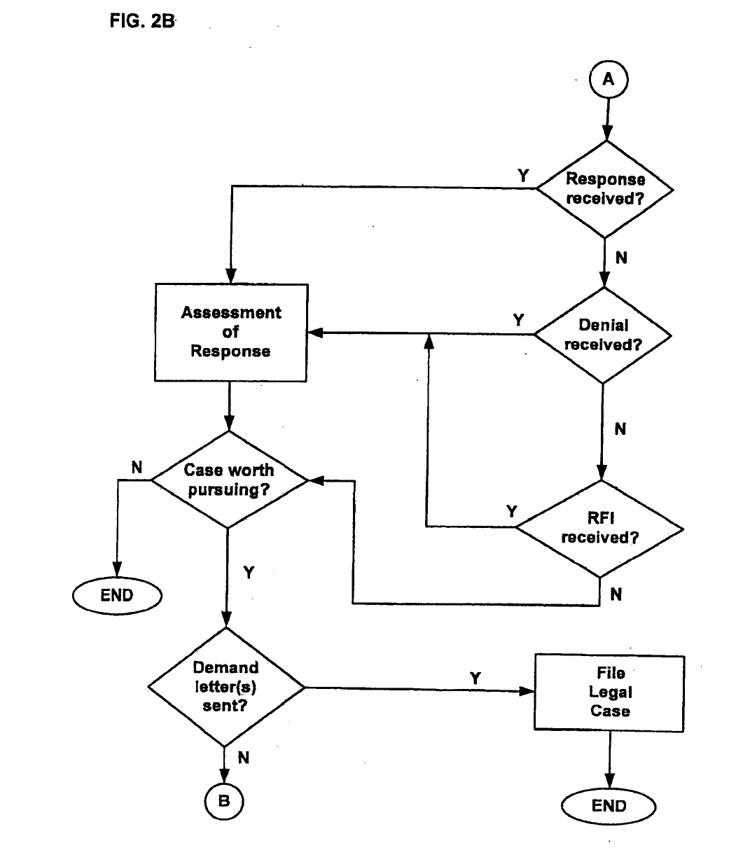

An exemplary embodiment of the present invention is based on the exemplary open system integrated architecture 100 shown in FIG. 1, and an associated method is illustrated in FIG. 2. Referring now to FIGS. 1, 2A and 2B, the exemplary open system integrated architecture 100 of the present invention may be based on, for example, a Healthcare Provider Interface Module 110, interacting with a Verification and Processing Module (VPM) 120. The architecture 100 may further include an Insurance Carrier Interaction/Billing (ICI) Module 130 and a Legal Portal/Collections (LP) Module 140, which may have an integrated Lawyer Interface Module 150. All modules may have interactive connections with each other and with a Data Storage Module 160, which may contain a Data Repository 180, such as a relational database, and an Image Repository 170, such as an image array. The structure and exemplary functioning of each module will be described in connection with the following exemplary embodiments. Functioning, however, is not limited to the modules as described.

In one exemplary embodiment, the method and system for integrated management of the submission, processing and resolution of healthcare-related no-fault insurance claims of the present invention may be implemented as an Internet-based or other network-based system that allows an end user of the system such as, for example, a physician, hospital, medical practice, chiropractor, acupuncturist, physical therapist, or any other provider of healthcare-related products or services, to input claim-related data into the Data Repository Module 160 via the Healthcare Provider Interface 110, which is connected to the system of the present invention through, for example, a secure connection. This information may be input prior to, simultaneously with, or after, providing claim-related healthcare services to the patient.

The database 160 may contain previously-input data regarding some-or all insurance carriers, and other claim-related information including, among other data, the name of the patient, the policy number, the date of service, the facility where the service is rendered, a claim-related incident description, and dates of hospitalization, if any. Further, the end user may input information regarding the therapies, procedures, and/or healthcare services or products provided, such as a diagnosis (e.g., a standardized code for the diagnosis) of the patient's condition, the type of healthcare service provided expressed in, for example, a standardized code, the type of medical procedure, and various other items of information. Upon completion of the input of information, for example upon saving the claim-related file, a unique claim identifier, such as a unique bar code, may then be assigned to the claim. The end user may then forward the completed claim, identified by the unique claim identifier, along with any underlying documentation, to the VPM 120.

It should be recognized by those skilled in the art that the claim and underlying documentation may be transmitted to the VPM 120 by any available transmission device and/or method, including, for example, electronically, via facsimile, hand delivery, or mail. In one exemplary embodiment, a cover sheet that includes the unique claim identifier (e.g., bar code) may accompany the transmission of the claim and underlying documentation. Upon receipt of the documents, in one exemplary embodiment, a VPM operator may scan the images and may store the scanned images in an image repository, such as an image array. In one exemplary embodiment of the invention, all images and subsequently created documents, including, for example, correspondence with the insurance carriers, additional claim-related information received and litigation/arbitration documents, are identified by the unique claim identifier and are related to the claim via the unique claim identifier.

In one exemplary embodiment, the VPM operator may review the claim and claim-related documentation for completeness and accuracy. It should be recognized by those skilled in the art that certain documents are required to make out a prima facie no-fault insurance claim. Such documents include, for example, an Assignment of Benefits form, a Referral form, and a Narrative, among others. In one exemplary embodiment, the required documents are designated as such, using a unique designation, to differentiate the required documents from all other documents, which may bear one or more different designations.

Upon making a determination regarding completeness and accuracy, the VPM operator may request additional claim-related information from the end user which, for example, may be the medical practice, or may forward to the insurance carrier claim information, either electronically or via paper copy, along with all documents required by the insurance carrier, which, in one exemplary embodiment, are stored in image form in a memory. In one exemplary embodiment, an attestation of service listing all documents that are being forwarded to the insurance carrier may be generated, which may be signed by the sender and notarized. In one embodiment, the documents may be forwarded to the insurance carrier by, e.g., certified U.S. mail, express mailing services (for example, Federal Express), or any other service that provides a receipt, such as a mailing receipt, that the documents have been sent.

The mailing receipt and attestation of service forms may then be imaged or otherwise stored in image format, and stored into the image repository as proof of mailing to the insurance carrier. In one embodiment, the mailing receipt and the attestation of service may also be identified with the unique claim identifier, for example, represented in barcode form, in order to correlate them with all other documents in the system related to the specific claim for which they were generated. In one embodiment, the attestation of service may include additional information, such as references to the action being performed, the identity of the sender of the documents, and the entity that received the documents. Thus, the attestation of service may be viewed at any time in order to provide proof that a specific action has been performed, or that specific documents have been filed, and the date on which these actions occurred.

In one exemplary embodiment, the VPM 120 may generate a feedback form, which may be returned to the end user as a Report. The Report may be a periodic report (e.g., weekly) that lists all claims received during the given period, with each claim being designated with its unique claim identifier. The Report may also contain a code for the procedures for which reimbursement is sought, and an Estimated Net Receivable amount, which reflects the lowest expected reimbursement that will be received. In addition, the Report may reflect any advances that have been or will be provided to the end user. The Report may also contain an indication of all incomplete cases, for which additional required information is requested from the end user, before processing of the claim may be initiated. The end user may also receive a Report containing only a listing of only those claims that the particular end user has selected.

In one exemplary embodiment of the present invention, all data related to the claims is stored in a single repository of data, such as a Structured Query Language (SQL) server database, which may contain pointers to the images stored in the data repository. It should be recognized by those skilled in the art, however, that alternative storage arrangements are possible. For example, all data and images may be stored in a single repository, or in multiple distributed repositories.

Upon sending out the claim form and accompanying documents to an insurance carrier, an accompanying attestation of service may be generated as proof that all the documents have been sent to the insurance carrier. The attestation of service may be stored in memory in the form of a scanned image or in other form, and may be linked to the unique claim identifier. The insurance carrier may respond by, for example, accepting the claim and forwarding payment, acknowledging the claim and sending a Request for Further Information (RFI), denying the claim, or simply not responding.

If payment is received, then the case may be closed, and respective payments are made to all interested parties, including the end user. If an RFI is received, then the ICI module 130 may check the documents sent to the insurance carrier for accuracy and completeness, and appropriate action may be taken, such as supplying any missing documents or sending to the insurance carrier the proof of previous mailing, along with all of the documents previously sent. In one exemplary embodiment, the method and system of the present invention may be used for providing receivable financing, such as advance funding, to an end user or claimant. The present invention may provide a predictive evaluation of the amount of payment to be received by the insurance carrier and the likelihood of such payment being made. Advance funding may be provided to a claimant based on the predicted amount and/or likelihood. If a denial is received from the insurance carrier, the ICI operator assesses the basis for the denial, and may take appropriate action, such as appealing the denial.

In one exemplary embodiment, all correspondence with the insurance carrier, including, for example, the USPS-stamped envelopes and/or the attestation of service as proof of the date of mailing, is scanned and stored into an image repository.

According to all applicable legal and procedural guidelines, for example, if the insurance carrier fails to respond within a certain period, or has wrongfully denied a claim and refused an appeal, or if one or more demand letters have been sent, the ICI module 130 transfers the claim to the LP module 140. At the discretion of the LP module operator, an appropriate action, such as the filing of a lawsuit, may be undertaken at that point.

In one exemplary embodiment, a search engine that enables searching of the data by any applicable data field and/or one or more letters of any field entry may be included in the systems and methods according to this invention. Data fields may include, for example, claim number, end user name, address and telephone number, treating practitioner, treatment provided, email address, insurance carrier name, address and telephone number, and insured/patient name, address and telephone number, among others fields.

Prior to filing a lawsuit, the LP module operator may select a law firm from a list of available firms, and select a particular lawyer to handle the case. Furthermore, legal particulars, such as appropriate venue and cause of action may be designated. The LP module operator may then create a Legal Case. In one exemplary embodiment, upon creation of the Legal Case, the case is displayed on a computer screen in a table of created legal cases, which shows the status of each created legal case. For example, the different states may mirror a litigation diagram, and may reflect a status such as: creation of legal case, generation of summons and complaint, service of process, receipt of answer, and all other actions and time periods that may occur in a litigation. The case automatically changes status as each time period expires or action occurs. For example, for a case in the “complaint and summons generated” state, the case remains in that state until the process server who serves the summons and complaint returns an Affidavit of Service. As soon as the Affidavit of Service is scanned into the system, the case is moved to the “summons and complaint served” status.

In one exemplary embodiment, the LP module has an integrated Lawyer Interface 150, through which a lawyer may review and sign all relevant documents prior to transmittal. The Lawyer Interface 150 provides access to a lawyer or legal practice to all cases assigned to that lawyer or legal practice. In another embodiment, the necessary legal papers may be reviewed and signed by a lawyer located at the site of the LP module 150 or at a remote location. Through the Lawyer Interface 150, a lawyer may draft and create documents in final form, and input scanned documents into the system. In one exemplary embodiment, a lawyer may have a scan now/scan later option allowing the lawyer to either scan the documents directly into the system, or create a coded (e.g., bar coded, or otherwise identified) cover sheet that may include the unique claim identifier and document type, and transmit the document to the LP module 140 for scanning. The LP module 140 may, among other functions, allow the tracking of all pending cases and their respective trial calendars in real time via a state diagram. The LP module 140, in one embodiment may also generate checks and track expenses associated with a particular legal case. The state diagram may include a variety of data relevant to the pending legal cases such as, for example, the duration for which the case has been pending, the billing history, scanned and stored images of all related documents including attestations of service, all the actions undertaken up until that point in time, and any templates for legal documents that include relevant data. According to various exemplary embodiments, the state diagram may be updated every time any action is performed in a pending legal case. This update may reflect any changes in the status of the case and any actions that need to be performed, the due dates these actions are to be performed, the entity that should perform the actions, and other relevant information. Thus, the state diagram may provide a real time overview of the history of one or more pending legal cases, and may reflect an up-to-date status for each pending case.

In one implementation, the LP module 140 and the Lawyer Interface 150 allow all lawyers and/or law firms to effectively and efficiently manage their litigation calendars and schedules. For example, upon pulling up a specific case, a lawyer may be immediately advised of the exact stage of litigation of the case, as well as receive related information, such as whether a deposition has been scheduled and for what date, whether a motion for Summary Judgment has been scheduled and for what date, how long the case has been in that stage, and how long the case is scheduled to remain in that stage, among other relevant information. In addition, the LP module 140 may allow a lawyer to view a complete history of the billing and collection activity associated with the case, and to view all images associated with that history. The LP module 140 may also enable the lawyer to create templates that may be otherwise used to print legal documents, such as stipulations and motions, among others, by retrieving or accessing data from the integrated data repository, and creating a completed document with all the relevant case information inserted and formatted. Thus, the LP module 140 and the Lawyer Interface 150 may be used as powerful tools in litigation and case management.

The present invention may be implemented using hardware, software or a combination thereof and may be implemented in one or more computer systems or other processing systems. In one exemplary embodiment, the present invention may be implemented using a Dream Weaver interface and Visual Basic programming.

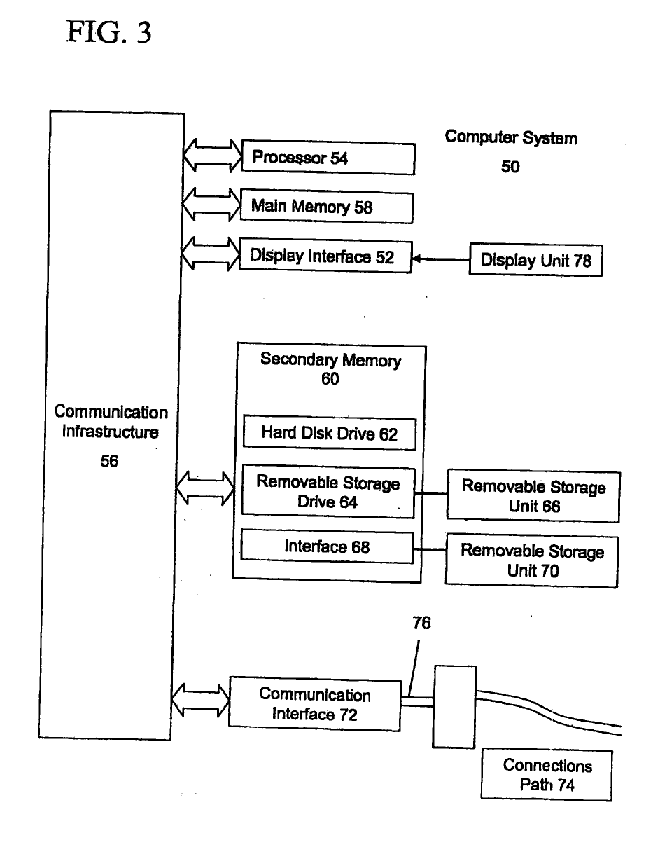

In one exemplary embodiment, the invention is directed toward one or more computer systems capable of carrying out the functionality described herein. An example of such a computer system 50 is shown in FIG. 3.

Computer system 50 includes one or more processors, such as processor 54. The processor 54 is connected to a communication infrastructure 56 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 50 can include a display interface 52 that forwards graphics, text, and other data from the communication infrastructure 56 (or from a frame buffer not shown) for display on the display unit 78. Computer system 50 also includes a main memory 58, preferably random access memory (“RAM”), and may also include a secondary memory 60. The secondary memory 60 includes, for example, a hard disk drive 62 and/or a removable storage drive 64, representing a floppy disk drive, a magnetic tape drive, an optical disk drive, etc. The removable storage drive 64 reads from and/or writes to a removable storage unit 66 in a well-known manner. Removable storage unit 66, represents a floppy disk, magnetic tape, optical disk, etc., which is read by and written to removable storage drive 64. As will be appreciated, the removable storage unit 66 includes a computer usable storage medium having stored therein computer software and/or data.

In alternative embodiments, secondary memory 60 includes other similar devices for allowing computer programs or other instructions to be loaded into computer system 50. Such devices include, for example, a removable storage unit 70 and an interface 68. Examples of such may include a program cartridge and cartridge interface (such as that found in video game devices), a removable memory chip (such as an erasable programmable read only memory (“EPROM”), or programmable read only memory (“PROM”)) and associated socket, and other removable storage units 70 and interfaces 68, which allow software and data to be transferred from the removable storage unit 70 to computer system 50.

Computer system 50 also includes, for example, a communications interface 72. Communications interface 72 allows software and data to be transferred between computer system 50 and external devices. Examples of communications interface 72 may include a modem, a network interface (such as an Ethernet card), a communications port, a Personal Computer Memory Card International Association (“PCMCIA”) slot and card, etc. Software and data transferred via communications interface 72 are in the form of signals 76, which may be electronic, electromagnetic, optical or other signals capable of being received by communications interface 72. These signals 76 are provided to communications interface 72 via a communications path (e.g., channel) 74. This path 74 carries signals 76 and may be implemented using wire or cable, fiber optics, a telephone line, a cellular link, a radio frequency (“RF”) link and/or other communications channels. In this document, the terms “computer program medium” and “computer usable medium” are used to refer generally to media such as a removable storage drive 64, a hard disk installed in hard disk drive 62, and signals 76. These computer program products provide software to the computer system 50. The invention is directed to such computer program products.

Computer programs (also referred to as computer control logic) are stored in main memory 58 and/or secondary memory 60. Computer programs may also be received via communications interface 72. Such computer programs, when executed, enable the computer system 50 to perform the features of the present invention, as discussed herein. In particular, the computer programs, when executed, enable the processor 54 to perform the features of the present invention. Accordingly, such computer programs represent controllers of the computer system 50.

In an embodiment where the invention is implemented using software, the software may be stored in a computer program product and loaded into computer system 50 using removable storage drive 64, hard drive 62, or communications interface 72. The control logic (software), when executed by the processor 54, causes the processor 54 to perform the functions of the invention as described herein. In another embodiment, the invention is implemented primarily in hardware using, for example, hardware components, such as application specific integrated circuits (“ASICs”). Implementation of the hardware state machine so as to perform the functions described herein will be apparent to persons skilled in the relevant art(s).

In yet another embodiment, the invention is implemented using a combination of both hardware and software.

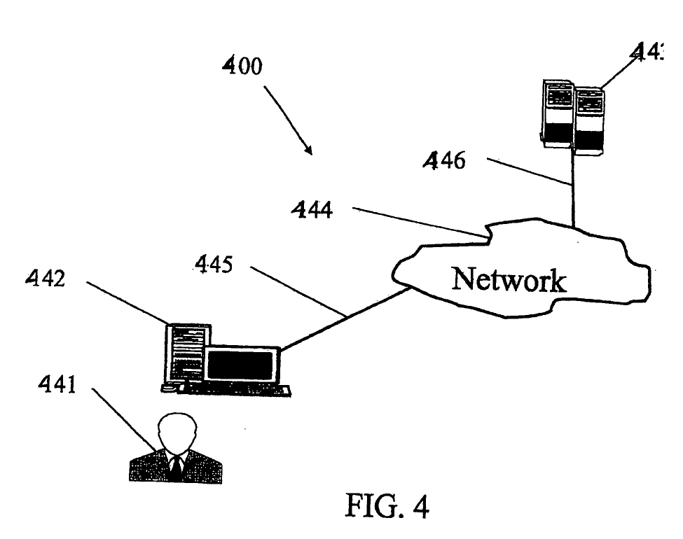

FIG. 4 shows a system 400 usable in accordance with an embodiment of the present invention. The system 400 includes an accessor 441 (also referred to interchangeably herein as a “user”) and a terminal 442. In one exemplary embodiment, data for use in accordance with the present invention is, for example, input and/or accessed by the accessor 441 via the terminal 442, such as a personal computer (PC), minicomputer, mainframe computer, microcomputer, telephonic device, or wireless device, such as a personal digital assistant (“PDA”) or a hand-held wireless device coupled to a server 443, such as a PC, minicomputer, mainframe computer, microcomputer, or other device having a processor and a repository for data and/or connection to a processor and/or repository for data, via, for example, a network 444, such as the Internet or an intranet, and couplings 445, 446. The couplings 445, 446 include, for example, wired, wireless, or fiber-optic links. In another embodiment, the method and system of the present invention operate in a stand-alone environment, such as on a single terminal.

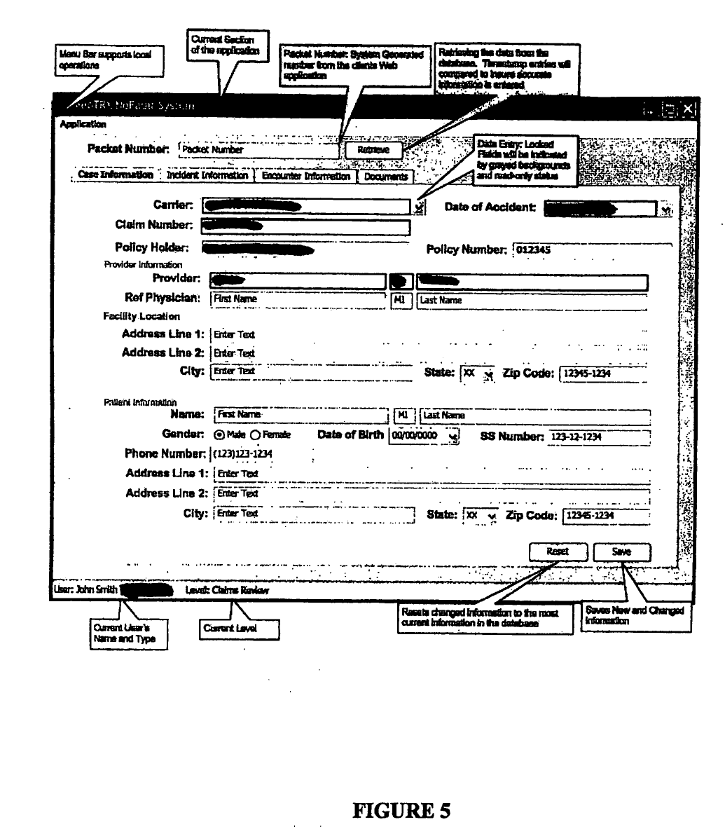

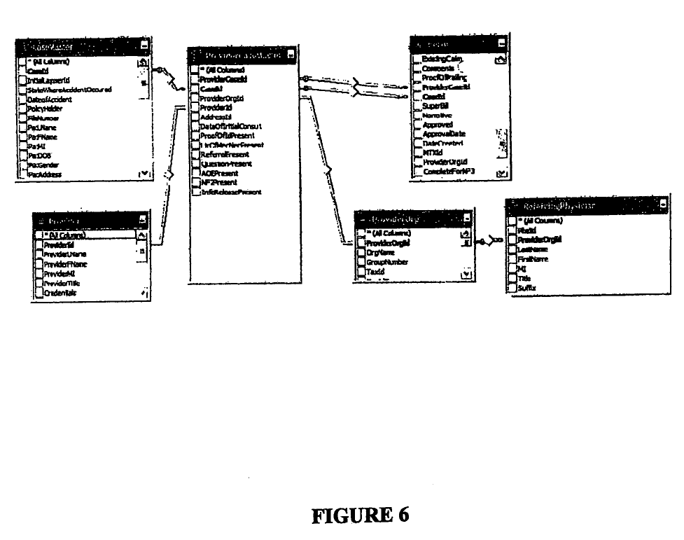

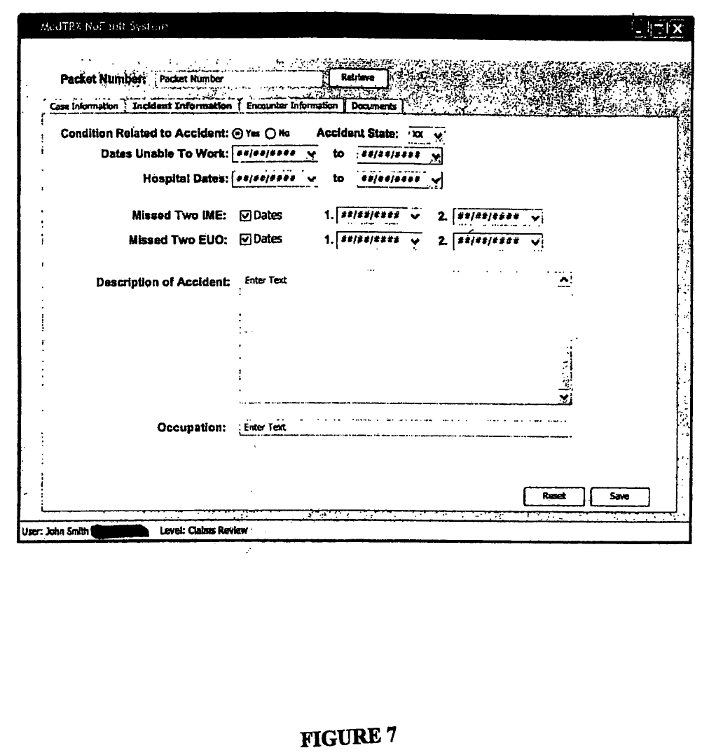

FIGS. 5-10 show various illustrations of claim forms and databases used according to various exemplary embodiments. For example, FIG. 5 is an illustration of a verification original screen, which may consist of a menu bar, a packet number entry, a retrieve button and several tabbed sections for data review, each tab section containing and Update button, a Reset button and a Submit button. FIG. 6 is an illustration of exemplary tables used in creating stored procedures for selecting, inserting and updating the data, and the various databases involved. Supporting lookup tables may also be used as needed. FIG. 7 is an illustration of an exemplary Incident Information form that may be used to verify the information related to a no-fault insurance claim and, for example, any related loss of work and hospitalization dates. The screen illustrated in FIG. 7 may be used, for example, to enter and validate incident-related information.

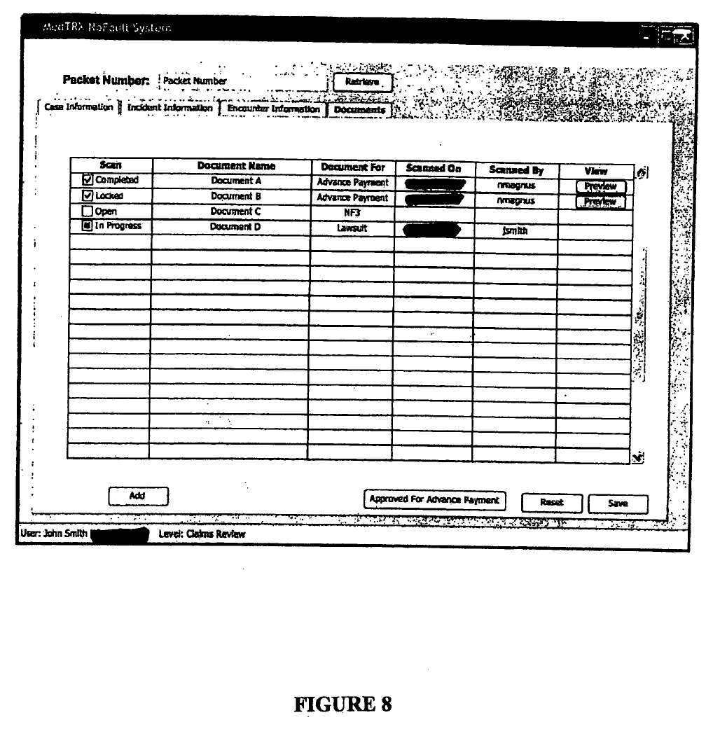

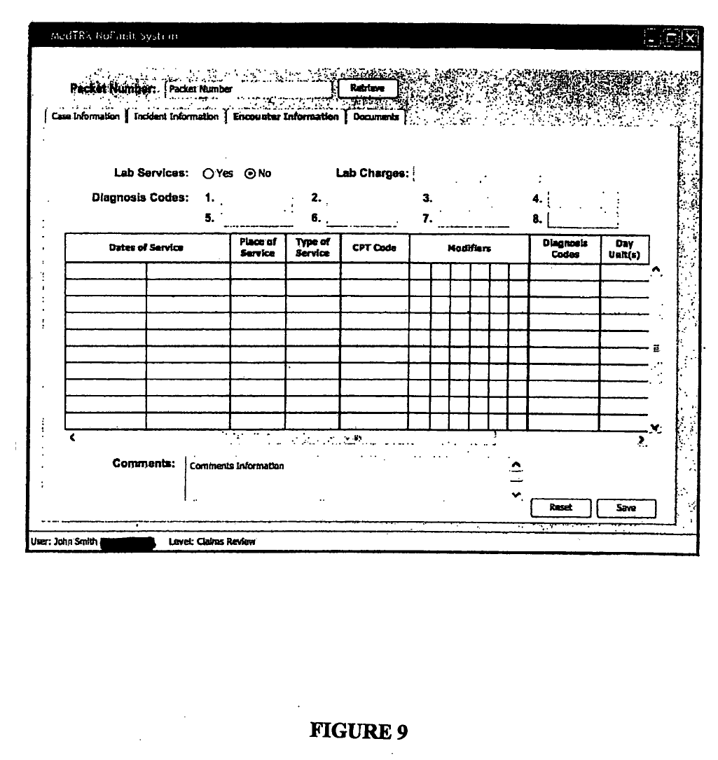

FIG. 8 is an illustration of a claim information section of the verification form represented in FIG. 5. In FIG. 8, document information such as the document name, whether the document has been scanned, when and by whom, and the purpose of the document, is illustrated for easy and direct access by a user. FIG. 9 is an illustration of a verification encounter information document used to enter the details of the encounter between the insurance provider and the patient or claimant. For example, unique diagnosis codes may be entered and associated with a date of service, location, type of service, and the like.

This disclosure is not intended to limit the invention to the integrated management of the submission, processing and resolution of healthcare-related no-fault insurance claims, as is more fully described herein. As should be recognized by those skilled in the art, other claims and processes may be integrated and managed using similar methods, and are intended to be included under this disclosure. Such claims and processes may be, for example, arbitration proceedings, U.S. litigation proceedings, or foreign litigation proceedings.

Furthermore, while this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for integrated claim processing, the method comprising:
receiving claim-related data in a memory;
generating a claim form and storing the claim form in the memory;
transmitting the claim form and any other claim-related documents to an insurance carrier;
receiving a determination of whether the claim will be paid by the insurance carrier; and
determining an appropriate course of action on the basis of the claim payment determination.

2. The method of claim 1, wherein the claim processing is for a no-fault insurance claim.

3. The method of claim 1, wherein the claim form is transmitted to the insurance carrier via at least one of selected from a group consisting of a network, the Internet, email, postal mail, facsimile and courier.

4. The method of claim 1, wherein the claim-related data comprises at least one selected from a group consisting of name of patient, policy number, date of service, facility where the service is rendered, incident description, dates of hospitalization, therapies, procedures, diagnosis of the patient's condition, and type of medical procedure.

5. The method of claim 1, wherein transmitting the claim form and other claim-related documents to the insurance carrier includes:
reviewing the claim-related data and the claim form before transmitting the claim form to the insurance carrier.

6. The method of claim 1, wherein the appropriate course of action comprises a legal action.

7. The method of claim 6, further comprising:
preparing a demand letter; and
transmitting the demand letter to the insurance carrier.

8. The method of claim 6, further comprising:
selecting an attorney from a list of available attorneys stored in memory;
determining venue and cause of action; and
filing suit.

9. The method of claim 6, further comprising:
generating a state diagram summarizing the status of a pending legal case.

10. The method of claim 9, wherein the state diagram reflects an up-to-status of a pending legal case.

11. The method of claim 1, wherein defining an appropriate course of action includes:
responding to a request for information received from the insurance carrier by performing at least one selected from a group consisting of submitting any missing documents and providing the insurance carrier with proof of previous correspondence.

12. The method of claim 1, wherein a list of insurance carriers is stored in the memory.

13. The method of claim 1, wherein a unique claim identifier is assigned to each claim being processed.

14. The method of claim 13, wherein the any other claim-related documents related to the claim are stored in the memory and are accessible via the unique claim identifier.

15. The method of claim 1, wherein generating the claim form comprises:
scanning related documents and storing the scanned documents in the memory.

16. The method of claim 13, further comprising:
compiling a periodic report on a status of all claims, each claim being identified by its unique claim identifier.

17. The method of claim 16, wherein the report comprises at least one selected from a group consisting of an estimated receivable amount, a progress of processing of each claim, and an identification of any incomplete cases.

18. The method of claim 1, wherein the claim form is automatically generated.

19. The method of claim 9, wherein the state diagram is updated every time an action is performed on a particular legal case.

20. The method of claim 1, wherein determining an appropriate course of action includes providing advance funding to a claimant.

21. A system for integrated of claim processing, the system comprising:
means for entering claim-related data in a memory,
means for automatically generating a claim form and storing the claim form in memory,
means for transmitting the claim form and any other claim-related documents to an insurance carrier,
means for determining whether the claim will be paid by the insurance carrier, and
means for taking appropriate course of action based on the determination.

22. A system for integrated of claim processing, the system comprising:
a processor;
a user interface functioning via the processor; and
a repository accessible by the processor; wherein the system:
receives claim-related data in a memory;
generates a claim form and stores the claim form in the memory;
transmits the claim form and any other claim-related documents to an insurance carrier;
receives a determination of whether the claim will be paid by the insurance carrier; and
determines an appropriate course of action on the basis of the claim payment determination.

23. The system of claim 22, further comprising:
a unique claim identifier assigned to the claim.

24. The system of claim 23, wherein the processor is housed on a terminal, and therein the terminal is selected from a group consisting of a personal computer, a minicomputer, a main frame computer, a microcomputer, a hand held device, and a telephonic device.

25. The system of claim 22, wherein the processor is housed on a server.

26. The system of claim 25, wherein the server is selected from a group consisting of a personal computer, a minicomputer, a microcomputer, and a main frame computer.

27. The system of claim 25, wherein the server is coupled to a network.

28. The system of claim 27, wherein the network is the Internet.

29. The system of claim 27, wherein the server is coupled to the network via a coupling.

30. The system of claim 27, wherein the coupling is selected from a group consisting of a wired connection, a wireless connection, and a fiberoptic connection.

31. The system of claim 22, wherein the repository is housed on a server.

32. The system of claim 31, wherein the server is coupled to a network.

33. A computer program product comprising a computer usable medium having control logic stored therein for causing a computer to integrate claim processing, the control logic comprising computer readable program code means for:
receiving claim-related data in a memory;
generating a claim form and storing the claim form in the memory;
transmitting the claim form and other claim-related documents to an insurance carrier;
receiving a determination of whether the claim will be paid by the insurance carrier; and
determining an appropriate course of action on the basis of the claim payment determination.

34. A method for integrated claim processing, the method comprising:
receiving claim-related data from one party in a dispute in a memory;
generating and storing into the memory a claim-related document directed to a second party in the dispute;
transmitting the claim-related document to the second party in the dispute;
receiving a response from the second party in the dispute;
based on the response received from the second party in the dispute, filing a claim-related legal action;
storing in the memory each claim-related document; and
maintaining a state diagram for the legal action, wherein the state diagram is updated upon a change in that status of the legal case.

35. The method of claim 34, wherein each claim-related document is stored in image form.

36. The method of claim 34, further comprising:
providing a unique identifier to identify each claim being processed; and
affixing the unique identifier to each document related to each claim being processed.

37. The method of claim 34, wherein the response from the second party in the dispute may be non-responsive.

38. The method of claim 34, wherein legal action is filed when the response from the second party in the dispute indicates that the second party in the dispute refuses to resolve the dispute.

39. A method for integrated claim processing, the method comprising:
receiving claim-related data from one party in a dispute in a memory;
generating and storing into the memory a plurality of claim-related documents;
transmitting one or more of the plurality of claim-related documents to a second party in the dispute;
generating an attestation of service for the transmittal of the one or more of the plurality of claim-related documents;
providing a unique identifier to identify each claim being processed;
affixing the unique identifier to each of the plurality of claim-related documents; and
providing an image copy of each of the plurality of claim-related documents;
wherein the attestation of service serves as proof of transmittal of the one or more of the plurality of claim-related documents to the second party in the dispute.

40. The method of claim 39, further comprising:
generating a mailing receipt for each of the plurality of claim-related documents.

41. A system for integrated claim processing, the system comprising:
receiving means for receiving claim-related data from one party in a dispute in a memory;
generating means for generating a claim-related document directed to a second party in the dispute;
storing means for storing into the memory the claim-related document directed to a second party in the dispute;
transmitting means for transmitting the claim-related document to the second party in the dispute;
receiving means for receiving a response from the second party in the dispute;
filing means for filing a claim-related legal action, based on the response received from the second party in the dispute;
storing means for storing in the memory each claim-related document; and
maintaining means for maintaining a state diagram for the legal action, wherein the state diagram is updated upon a change in that status of the legal case.

42. The system of claim 40, wherein each claim-related document is stored in image form.

43. The system of claim 41, further comprising:
providing means for providing a unique identifier to identify each claim being processed; and
affixing means for affixing the unique identifier to each document related to each claim being processed.

44. A system for integrated claim processing, the system comprising:
receiving means for receiving claim-related data from one party in a dispute in a memory;
generating means for generating a claim-related document directed to a second party in the dispute;
storing means for storing into the memory the claim-related document directed to a second party in the dispute;
transmitting means for transmitting one or more of the plurality of claim-related documents to a second party in the dispute;
generating means for generating an attestation of service for the transmittal of the one or more of the plurality of claim-related documents;
providing means for providing a unique identifier to identify each claim being processed;
affixing means for affixing the unique identifier to each of the plurality of claim-related documents; and
providing means for providing an image copy of each of the plurality of claim-related documents;
wherein the attestation of service serves as proof of transmittal of the one or more of the plurality of claim-related documents to the second party in the dispute.

45. The system of claim 44, further comprising:
generating means for generating a mailing receipt for each of the plurality of claim-related documents.
